(19) United States
(12) Patent Application Publication
(10) Pub. No.: US 2026/0214022 A1
(43) Pub. Date: Jul. 23, 2026

(54) METHOD AND APPARATUS FOR CONTROLLING COMMUNICATION LINK BETWEEN COMMUNICATION DEVICES

(71) Applicant: Telefonaktiebolaget LM Ericsson (publ), Stockholm (SE)

(72) Inventors: Zhan ZHANG, Beijing (CN); Ming LI, Stockholm (SE); Rakesh RANJAN, Jarfalla (SE)

(21) Appl. No.: 19/139,539

(22) PCT Filed: Dec. 6, 2023
(86) PCT No.: PCT/CN2023/136818

§ 371 Date: Jun. 16, 2025

(30) Foreign Application Priority Data
Dec. 16, 2022 (WO) PCT/CN2022/139628

(51) Int. Cl. H04L 41/16; H04L 43/065; H04L 43/087

(52) U.S. Cl. CPC H04L 41/16; H04L 43/065; H04L 43/087

(57) ABSTRACT

Embodiments of the present disclosure provide methods and apparatus for controlling communication link between communication devices. A method (100) performed by a network node, may comprise: transmitting an instruction to a terminal device, to activate the communication link; and communicating with the terminal device, by using the communication link. The communication link is of a first type or a second type The first type of communication link is based on data driven artificial intelligence. At least two types of communication link may be utilized. Particularly, communication link based on data driven artificial intelligence may be selected from these two types of communication links, according to scenarios.

### RELATED APPLICATION

This application claims priority from PCT Application No. PCT/CN2022/139628, filed on Dec. 16, 2022, which is incorporated herein in its entirety by reference.

### TECHNICAL FIELD

The present disclosure relates generally to the technology of communication technology, and in particular, to a method and an apparatus for controlling communication link between communication devices.

### BACKGROUND

This section introduces aspects that may facilitate better understanding of the present disclosure. Accordingly, the statements of this section are to be read in this light and are not to be understood as admissions about what is in the prior art or what is not in the prior art.

In current communication systems, the communication links between different communication devices are all built based on human expertise on physical and mathematical derivations. Such solution could be seen as model-driven (particularly, driven by fixed physical/mathematical model) where the approach is governed by a set of equations. For example, Fourier transform or Kalman filtering are used in communication systems.

However, such fixed physical/mathematical model might not provide optimized solutions for various scenarios.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Certain aspects of the present disclosure and their embodiments may provide solutions to these or other challenges. There are, proposed herein, various embodiments which address one or more of the issues disclosed herein. Improved methods and apparatuses are provided for controlling communication link between communication devices.

According to a first aspect of the present disclosure, there is provided a method performed by a network node. The method comprises: transmitting an instruction to a terminal device, to activate the communication link; and communicating with the terminal device, by using the communication link. The first type of communication link is based on data driven artificial intelligence. The communication link is of a first type or a second type. Optionally, before transmitting the instruction to the terminal device, the method may further comprise: determining to use a communication like of a first type or a second type, and the instruction may activate the determined communication link.

In exemplary embodiments of the present disclosure, the instruction configures and/or schedules the communication link.

In exemplary embodiments of the present disclosure, the second type of communication link is based on model-driven design utilizing expertise on physics and mathematical derivations.

In exemplary embodiments of the present disclosure, the second type of communication link is based on at least one of: 2G, 3G, 4G, or 5G communication standard.

In exemplary embodiments of the present disclosure, the method may further comprise: transmitting to the terminal device a configuration for the communication link to receive or transmit data, or to provide a report; determining to use the communication link of the first type or the second type, based at least on the report. The type of the communication link may be used based at least on the report.

In exemplary embodiments of the present disclosure, the report comprises at least one of: a transmission error rate; a signal to noise ratios; a signal strength; doppler shifts; a capability of the terminal device to support the first type of communication link and/or the second type of communication link; and/or a computing capability of the terminal device.

In exemplary embodiments of the present disclosure, the method may further comprises: transmitting an instruction to the terminal device to download a pre-trained data-driven model, when the type of communication link is the first type.

In exemplary embodiments of the present disclosure, the method may further comprise: transmitting an instruction to the terminal device to deactivate the first type of communication link and fallback to the second type of communication link.

In exemplary embodiments of the present disclosure, the communication link comprises at least radio resource control unit, media access control unit, and signal frame generation unit. At least one of the radio resource control unit, the media access control unit, and/or the signal frame generation unit of the first type of communication link comprises a data-driven module.

In exemplary embodiments of the present disclosure, the first type of communication link is configured for user plane, the second type of communication link is configured for control plane; and/or the first type of communication link and the second communication link are configured to use different radio resource blocks or same radio resource bands but at different time occasions.

In exemplary embodiments of the present disclosure, the first type is used, in at least one of the following condition: when the terminal device is in a high mobility or severe phase jittering case; when a link hardware impairment happens in the second type of communication link; and/or when the first type of communication link has a higher transmission efficiency than the second type of communication link.

In exemplary embodiments of the present disclosure, the second type is used, in at least one of the following condition: when the first type of communication link has a lower transmission efficiency than the second type of communication link; when a degradation due to model-drift happens in the first type of communication link; when a radio environment is suitable for the second type of communication link; and/or when a computing resource is insufficient to support the first type of communication link.

In exemplary embodiments of the present disclosure, the network node uses a radio resource control signaling, downlink/uplink control information and/or media access control command to instruct the terminal device; and/or the network node comprises a base station.

According to a second aspect of the present disclosure, there is provided a method performed by a terminal device. The method may comprise: receiving an instruction from a network node, to activate a communication link; and communicating with the network node, by using the communication link. The communication link is a first type of communication link or a second type of communication link. The first type of communication link is based on data driven artificial intelligence.

In exemplary embodiments of the present disclosure, the instruction configures and/or schedules the communication link.

In exemplary embodiments of the present disclosure, the second type of communication link is based on model-driven design utilizing expertise on physics and mathematical derivations.

In exemplary embodiments of the present disclosure, the second type of communication link is based on at least one of: 2G, 3G, 4G, or 5G communication standard.

In exemplary embodiments of the present disclosure, the method may further comprise: receiving from the network node a configuration for the communication link to receive or transmit data, or to provide a report. The type of the communication link may be used based at least on the report.

In exemplary embodiments of the present disclosure, the report comprises at least one of: a transmission error rate; a signal to noise ratios; a signal strength; doppler shifts; a capability of the terminal device to support the first type of communication link and/or the second type of communication link; and/or a computing capability of the terminal device.

In exemplary embodiments of the present disclosure, the method may further comprises: receiving an instruction from the network node to download a pre-trained data-driven model, when the type of communication link is the first type.

In exemplary embodiments of the present disclosure, the method may further comprise: receiving an instruction from the network node to deactivate the first type of communication link and fallback to the second type of communication link.

In exemplary embodiments of the present disclosure, the method may further comprise: training a model in the first type of communication link with data/feedback and configuration specified over the second type of communication link.

In exemplary embodiments of the present disclosure, the method may further comprise: enabling or disabling the first type of communication link, based on comparison between performance of the first type of communication link and the second type of communication link.

In exemplary embodiments of the present disclosure, the communication link comprises at least radio resource control unit, media access control unit, and signal frame generation unit; and at least one of the radio resource control unit, the media access control unit, and/or the signal frame generation unit of the first type of communication link comprises a data-driven module.

In exemplary embodiments of the present disclosure, the first type of communication link is configured for user plane, the second type of communication link is configured for control plane; and/or the first type of communication link and the second communication link are configured to use different radio resource blocks or same radio resource bands but at different time occasions.

In exemplary embodiments of the present disclosure, the first type is used, in at least one of the following condition: when the terminal device is in a high mobility or severe phase jittering case; when a link hardware impairment happens in the second type of communication link; and/or when the first type of communication link has a higher transmission efficiency than the second type of communication link.

In exemplary embodiments of the present disclosure, the second type is used, in at least one of the following condition: when the first type of communication link has a lower transmission efficiency than the second type of communication link; when a degradation due to model drift happens in the first type of communication link; when a radio environment is suitable for the second type of communication link; and/or when a computing resource is insufficient to support the first type of communication link.

In exemplary embodiments of the present disclosure, the terminal device uses a radio resource control signaling, downlink/uplink control information and/or media access control command to receive an instruction from the network node; and/or the network node comprises a base station.

According to a third aspect of the present disclosure, there is provided an apparatus for a network node. The apparatus may comprise: a processor; and a memory, the memory containing instructions executable by the processor. The apparatus for the network node is operative for: transmitting an instruction to a terminal device, to activate the communication link; and communicating with the terminal device, by using the communication link. The first type of communication link is based on data driven artificial intelligence. The communication link is of a first type or a second type. Optionally, the apparatus may be further operative for: before transmitting the instruction to the terminal device, determining to use a communication like of a first type or a second type. The instruction may activate the determined communication link.

In exemplary embodiments of the present disclosure, the apparatus is further operative to perform the method according to any exemplary embodiments of the first aspect.

According to a fourth aspect of the present disclosure, there is provided an apparatus for a terminal device, comprising: a processor; and a memory, the memory containing instructions executable by the processor. The apparatus for the terminal device is operative for: receiving an instruction from a network node, to activate a communication link; and communicating with the network node, by using the communication link. The communication link is a first type of communication link or a second type of communication link; and the first type of communication link is based on data driven artificial intelligence.

In exemplary embodiments of the present disclosure, the apparatus is further operative to perform the method according to any exemplary embodiments of the second aspect.

According to a fifth aspect of the present disclosure, there is provided an apparatus for a communication device, comprising: a heterogeneous transceiver. The heterogeneous transceiver comprises a first type of transceiver and a second type of transceiver; and the first type of transceiver is based on data driven artificial intelligence.

In exemplary embodiments of the present disclosure, the second type of transceiver is based on model-driven design utilizing expertise on physics and mathematical derivations.

In exemplary embodiments of the present disclosure, the first type of transceiver comprises a machine learning transceiver; and/or the second type of transceiver comprise a model-driven transceiver based on at least one of: 2G, 3G, 4G, or 5G communication standard.

In exemplary embodiments of the present disclosure, at least one of a radio resource control unit, a media access control unit, and/or a signal frame generation unit of the first type of transceiver comprises a data-driven module.

According to a sixth aspect of the present disclosure, there is provided a computer-readable storage medium storing instructions which when executed by at least one processor, cause the at least one processor to perform the method according to any exemplary embodiments of the first or second aspect.

Embodiments herein afford many advantages. For example, in embodiments herein, at least two types of communication link may be utilized. Particularly, communication link based on data driven artificial intelligence may be selected from these two types of communication links, according to scenarios. Learning capability of artificial intelligence creates advantageous policy or strategies directly based on data instead of human logics and symbolic modeling and analysis. Therefore, the solution for communication links might be superior.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary flow chart showing a method performed by a network node, according to exemplary embodiments of the present disclosure.

FIG. 1B is an exemplary flow chart showing additional steps of the method as shown in FIG. 1A, according to embodiments of the present disclosure.

FIG. 1C is an exemplary flow chart showing additional steps of the method as shown in FIG. 1A, according to embodiments of the present disclosure.

FIG. 2A is an exemplary flow chart showing a method performed by a terminal device, according to exemplary embodiments of the present disclosure.

FIG. 2B is an exemplary flow chart showing additional steps of the method as shown in FIG. 2A, according to embodiments of the present disclosure.

FIG. 2C is an exemplary flow chart showing additional steps of the method as shown in FIG. 2A, according to embodiments of the present disclosure.

FIG. 2D is an exemplary flow chart showing additional steps of the method as shown in FIG. 2A, according to embodiments of the present disclosure.

FIG. 3 is a diagram showing an example of structure and key components of proposed heterogeneous transceiver, according to embodiments of the present disclosure.

FIG. 4 is a diagram showing one example of control procedure including baseline of key control procedure and signaling, according to embodiments of the present disclosure.

FIG. 5 is a block diagram showing exemplary apparatuses suitable for practicing a network node, according to embodiments of the disclosure.

FIG. 6 is a block diagram showing exemplary apparatuses suitable for practicing a terminal device, according to embodiments of the disclosure.

FIG. 7 is a block diagram showing exemplary apparatuses suitable for practicing a communicating device, according to embodiments of the disclosure.

FIG. 8 is a block diagram showing an apparatus readable storage medium, according to embodiments of the present disclosure.

FIG. 9A is a schematic showing units for the apparatus for a network node, according to embodiments of the present disclosure.

FIG. 9B is a schematic showing units for the apparatus for a terminal device, according to embodiments of the present disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable wireless communication standards. For example, the wireless communication standards may comprise 5^{th} generation (5G), new radio (NR), 4^{th} generation (4G), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “apparatus” used herein may refer to a network device or network entity or network function or any other devices (physical or virtual) in a communication network, namely, a network node/device. For example, the “apparatus” in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the “apparatus” may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “apparatus” may also refer to any suitable function which can be implemented in a network entity (physical or virtual) of a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), OAM (Operation Administration and Maintenance) etc. In other embodiments, the network function may comprise different types of NFs (such as PCRF (Policy and Charging Rules Function), etc.) for example depending on the specific network.

The term “apparatus” may further refer to any end device that can access a communication network and receive services therefrom, namely, a terminal device. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

Nowadays, whenever 6G or future generation network is a subject for a discussion, AI (artificial intelligence) (e.g., machine learning based data driven solution) could be the most critical enabler of a lot of enhancements and is regarded as a key leverage to transform the whole design philosophy to a new level of adaptivity to customize the radio system to fit into concrete and distinct radio environments. Learning capability of AI creates advantageous policy or strategies directly based on data instead of human logics and symbolic modeling and analysis.

AI/ML enabled solutions essentially employ data-driven learning approaches where the models learn the underlying data distribution and relationship between the inputs and outputs without the need for understanding the underlying complex processes. They mainly rely on statistical techniques.

On the contrary, legacy solutions could be seen as model-driven where the approach is governed by a set of equations. For example, Fourier transform or Kalman filtering are used in communication systems.

Data-driven learning approach is a promising application of machine learning for physical layer at radio system. It has the following potentials.
It is a path to design transceivers fully adaptive to radio environment.
It provides possible performance gains over general modeling or inaccurate modeling-based system.
It can reduce product design cycles with more general modeling.

Meanwhile, at the current stage, it has been observed to incur the following challenges in reality.
It causes scheme's generality issues (especially for offline training), and its training efficiency varies in different scenarios.
It needs feedback loop availability and quality for online training & efficiency.

As aforementioned challenges, though ML based solution might be superior at some cases in performance, its generality issue is still not fully consolidated or examined. This is owing to that radio environment could be very diversified in many dimensions, such as, time, frequency and spaces, radio sets, channels, etc. In one hand, it is hard to collect data at all cases for training purposes. On the other hand, it is also hard to ensure a so-called completeness of the testing cases. Both pose a severe issue and concern for a large scale of data-driven function usage, especially, for commercial uses or for an infrastructure of a society where reliability is of top requirements.

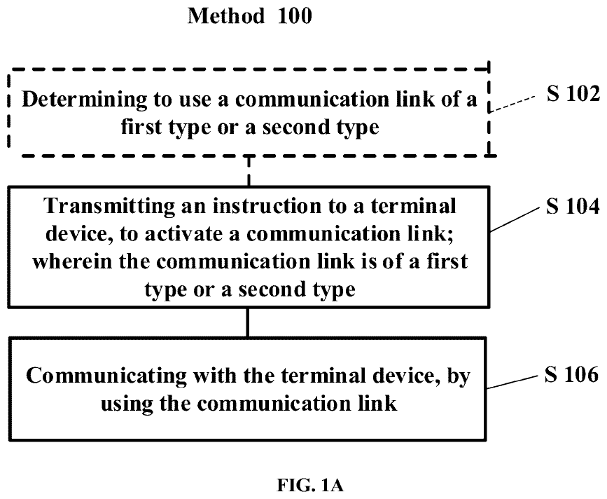

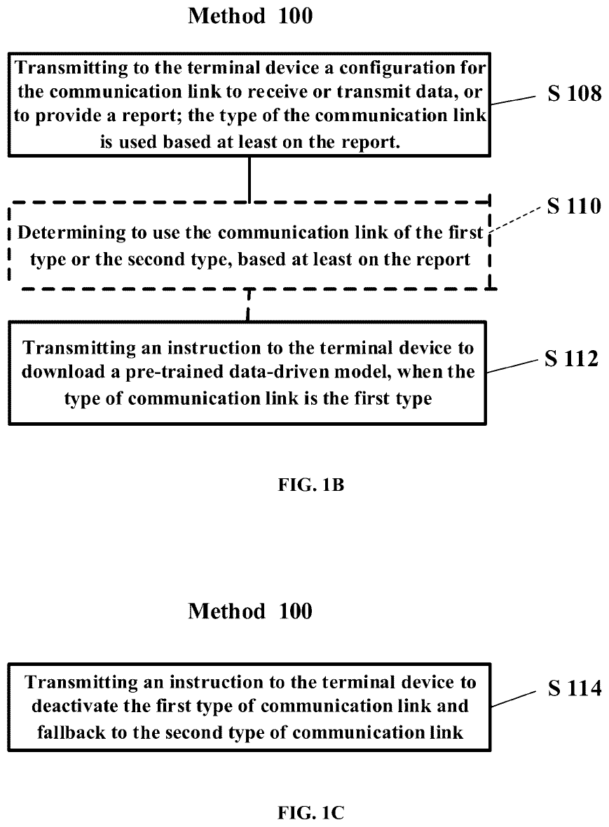

FIG. 1A is an exemplary flow chart showing a method performed by a network node, according to exemplary embodiments of the present disclosure.

As shown in FIG. 1A, the method 100 comprises: a step S104, transmitting an instruction to a terminal device, to activate the communication link; and a step S106, communicating with the terminal device, by using the communication link. The communication link is of a first type or a second type. The first type of communication link is based on data driven artificial intelligence.

Optionally, the method 100 may further comprise: a step S102 before the step S104, determining to use a communication link of a first type or a second type.

According to embodiments of the present disclosure, at least two types of communication link may be utilized. Particularly, communication link based on data driven artificial intelligence may be selected from these two types of communication links, according to scenarios. Learning capability of artificial intelligence creates advantageous policy or strategies directly based on data instead of human logics and symbolic modeling and analysis. Therefore, the solution for communication links might be superior.

In exemplary embodiments of the present disclosure, the instruction configures and/or schedules the communication link.

In exemplary embodiments of the present disclosure, the second type of communication link is based on model-driven design utilizing expertise on physics and mathematical derivations.

In exemplary embodiments of the present disclosure, the second type of communication link is based on at least one of: 2G, 3G, 4G, or 5G communication standard.

According to embodiments of the present disclosure, it proposes a scheme for radio transceiver formulation and link/network control to integrate an ML based data-driven function blocks and its legacy model-driven scheme (conventional scheme) into a heterogeneous radio transceiver (or function blocks) to get a better trade-off on performance and generality (reliability).

FIG. 1B is an exemplary flow chart showing additional steps of the method as shown in FIG. 1A, according to embodiments of the present disclosure.

In exemplary embodiments of the present disclosure, the method may further comprise: a step S108, transmitting to the terminal device a configuration for the communication link to receive or transmit data, or to provide a report. The type of the communication link may be used based at least on the report.

Optionally, the method may further comprise: a step S110, determining to use the communication link of the first type or the second type, based at least on the report.

Further, the method may further comprise: a step S112, transmitting an instruction to the terminal device to download a pre-trained data-driven model, when the type of communication link is the first type.

According to embodiments of the present disclosure, the determination of which type of communication to be used may be based on timely measurement and report about the communication circumstances.

Further, the terminal device may download newest data-driven model, to remain synchronization with the network side.

In exemplary embodiments of the present disclosure, the report comprises at least one of: a transmission error rate; a signal to noise ratios; a signal strength; doppler shifts; a capability of the terminal device to support the first type of communication link and/or the second type of communication link; and/or a computing capability of the terminal device.

FIG. 1C is an exemplary flow chart showing additional steps of the method as shown in FIG. 1A, according to embodiments of the present disclosure.

In exemplary embodiments of the present disclosure, the method may further comprise: a step S114, transmitting an instruction to the terminal device to deactivate the first type of communication link and fallback to the second type of communication link.

According to embodiments of the present disclosure, the AI link (the first type) and its associated fallback link (the second type) inter-act with each other to selectively maintain the link reliability and transmission efficiency.

In exemplary embodiments of the present disclosure, the communication link comprises at least radio resource control unit, media access control unit, and signal frame generation unit. At least one of the radio resource control unit, the media access control unit, and/or the signal frame generation unit of the first type of communication link comprises a data-driven module.

In exemplary embodiments of the present disclosure, the first type of communication link is configured for user plane, the second type of communication link is configured for control plane; and/or the first type of communication link and the second communication link are configured to use different radio resource blocks or same radio resource bands but at different time occasions.

In exemplary embodiments of the present disclosure, the first type is used, in at least one of the following condition: when the terminal device is in a high mobility or severe phase jittering case; when a link hardware impairment happens in the second type of communication link; and/or when the first type of communication link has a higher transmission efficiency than the second type of communication link.

In exemplary embodiments of the present disclosure, the second type is used, in at least one of the following condition: when the first type of communication link has a lower transmission efficiency than the second type of communication link; when a degradation due to model-drift happens in the first type of communication link; when a radio environment is suitable for the second type of communication link; and/or when a computing resource is insufficient to support the first type of communication link.

In exemplary embodiments of the present disclosure, the network node uses a radio resource control signaling, downlink/uplink control information and/or media access control command to instruct the terminal device; and/or the network node comprises a base station.

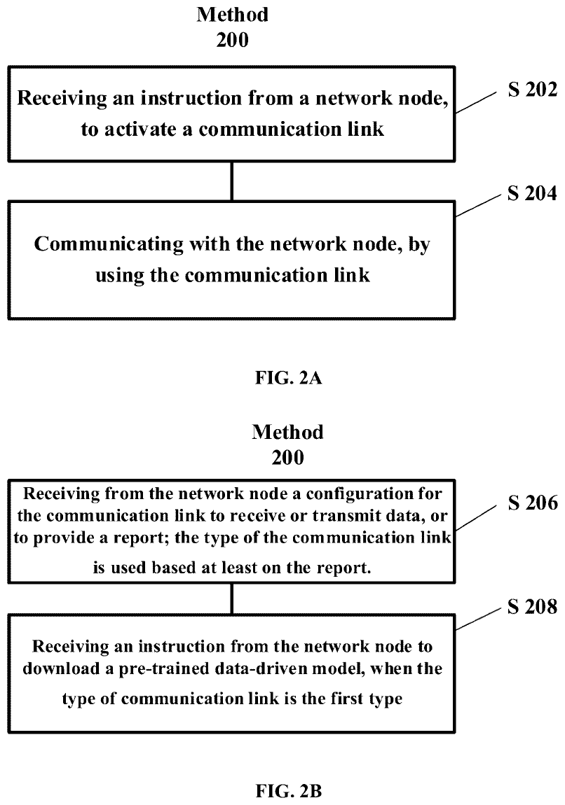

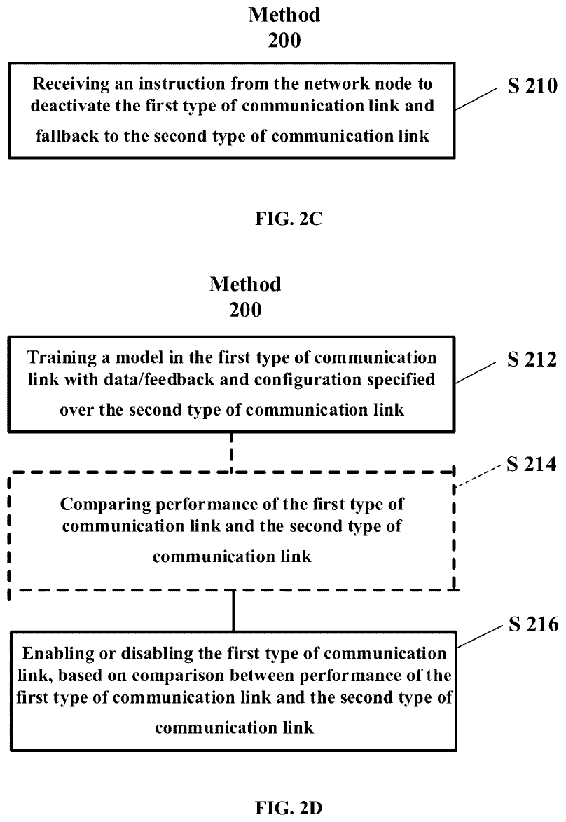

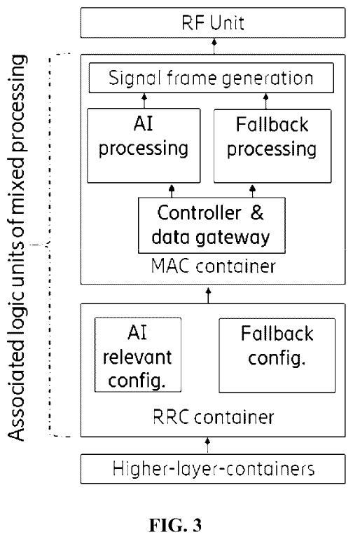

FIG. 2A is an exemplary flow chart showing a method performed by a terminal device, according to exemplary embodiments of the present disclosure.

As shown in FIG. 2A, the method 200 may comprise: a step S202, receiving an instruction from a network node, to activate a communication link; and a step S204, communicating with the network node, by using the communication link. The communication link is a first type of communication link or a second type of communication link. The first type of communication link is based on data driven artificial intelligence.

In exemplary embodiments of the present disclosure, the instruction configures and/or schedules the communication link.

In exemplary embodiments of the present disclosure, the second type of communication link is based on model-driven design utilizing expertise on physics and mathematical derivations.

In exemplary embodiments of the present disclosure, the second type of communication link is based on at least one of: 2G, 3G, 4G, or 5G communication standard.

FIG. 2B is an exemplary flow chart showing additional steps of the method as shown in FIG. 2A, according to embodiments of the present disclosure.

As shown in FIG. 2B, the method 200 may further comprise: a step S206, receiving from the network node a configuration for the communication link to receive or transmit data, or to provide a report; the type of the communication link may be used based at least on the report; and/or a step S208, receiving an instruction from the network node to download a pre-trained data-driven model, when the type of communication link is the first type.

In exemplary embodiments of the present disclosure, the report comprises at least one of: a transmission error rate; a signal to noise ratios; a signal strength; doppler shifts; a capability of the terminal device to support the first type of communication link and/or the second type of communication link; and/or a computing capability of the terminal device.

FIG. 2C is an exemplary flow chart showing additional steps of the method as shown in FIG. 2A, according to embodiments of the present disclosure.

As shown in FIG. 2C, the method 200 may further comprise: a step S210, receiving an instruction from the network node to deactivate the first type of communication link and fallback to the second type of communication link.

FIG. 2D is an exemplary flow chart showing additional steps of the method as shown in FIG. 2A, according to embodiments of the present disclosure.

As shown in FIG. 2D, the method 200 may further comprise: a step S212, training a model in the first type of communication link with data/feedback and configuration specified over the second type of communication link; and/or a step S216, enabling or disabling the first type of communication link, based on comparison between performance of the first type of communication link and the second type of communication link.

Optionally, the method 200 may further comprise: a step S214, comparing performance of the first type of communication link and the second type of communication link.

In exemplary embodiments of the present disclosure, the communication link comprises at least radio resource control unit, media access control unit, and signal frame generation unit; and at least one of the radio resource control unit, the media access control unit, and/or the signal frame generation unit of the first type of communication link comprises a data-driven module.

In exemplary embodiments of the present disclosure, the first type of communication link is configured for user plane, the second type of communication link is configured for control plane; and/or the first type of communication link and the second communication link are configured to use different radio resource blocks or same radio resource bands but at different time occasions.

In exemplary embodiments of the present disclosure, the first type is used, in at least one of the following condition: when the terminal device is in a high mobility or severe phase jittering case; when a link hardware impairment happens in the second type of communication link; and/or when the first type of communication link has a higher transmission efficiency than the second type of communication link.

In exemplary embodiments of the present disclosure, the second type is used, in at least one of the following condition: when the first type of communication link has a lower transmission efficiency than the second type of communication link; when a degradation due to model drift happens in the first type of communication link; when a radio environment is suitable for the second type of communication link; and/or when a computing resource is insufficient to support the first type of communication link.

In exemplary embodiments of the present disclosure, the terminal device uses a radio resource control signaling, downlink/uplink control information and/or media access control command to receive an instruction from the network node; and/or the network node comprises a base station.

According to embodiments of the present disclosure, it proposes a scheme for radio transceiver formulation and link/network control to integrate an ML based data-driven function blocks and its legacy model-driven scheme (conventional scheme) into a heterogeneous radio transceiver (or function blocks) to get a better tradeoff on performance and generality (reliability), as well as facilitate drive test on the AI functions at radio.

In the following sections, data-driven transceiver (TRX) is used as a general term to refer many options of data-driven (AI driven) function blocks/unit/transmitter/receiver functions.

Performance in both reliability and spectrum efficiency is expected to be enhanced with the transceiver scheme and control on the link operations proposed by embodiments of the present disclosure, at cellular network, for an instance.

Firstly, the exemplary embodiments may define association of operations and its structure of associated parts of heterogeneous transceiver, propose its internal operating mechanisms, signaling for control procedure of communication links.

Namely, the important improvements of the exemplary embodiments may include:
1. proposal on heterogeneous transceiver consisting of ML transceiver (or data-driven function blocks) and its fallback transceiver (legacy model-driven TRX or function blocks);
2. control signaling and procedure.

Usually, a data-driven TRX (function block) could outperform the model driven ones since a data-driven TRX (or function) could capture and adapt better on the radio environments including many impairments of hardware or errors owing to coarse/over-simplified modeling. However, the data-driven model does not always have a robustness as model-driven ones over wide scenarios and diversified cases, if the training & testing are based on limited data set.

In contrast, model driven scheme (conventional scheme) might have a wide applicability with modest performance with a higher likelihood.

Therefore, an integrated scheme with both of data-driven and model driven ones and prudent and selective use of them might exhibit a balanced reliability and superior performance. This proposal essentially is one kind of radio diversity enabler.

2ndly, Minimization of Drive Tests (MDT) was standardized for NR in 3GPP standards Release-16 to reduce the amount of drive tests performed manually. It is a UE assisted framework where network measurements are collected by both IDLE/INACTIVE and RRC_CONNECTED UE(s) to aid the network in gathering valuable information. It has been specified for both LTE and NR in 3GPP TS 37.320 V17.1.0 (2022-06) “Radio measurement collection for Minimization of Drive Tests (MDT); Overall description; Stage 2 (Release 17)”. In exemplary embodiments of the present disclosure, an MDT feature on these heterogeneous functions is recommended to facilitate the initial validation of AI modules in the radio.

In term of minimization of Drive Tests (MDT) on the data-driven models (functions), for an example, the UE is configured with ML-TRX (machine learning based transceiver) and C-TRX (conventional transceiver) as part of the logged MDT configuration that indicates to the UE that the UE shall perform the logging of MDT measurements when the UE switches ML-TRX and C-TRX. This would greatly facilitate the drive test for AI enabled models/functions.

Therefore, exemplary embodiments may define a new kind of heterogeneous transceiver to enable radio diversity to enhance performance in both the spectrum efficiency as well as link reliability. It consists of ML transceiver and its associated fallback (conventional) transceiver. The ML transceiver and its associated TRX fallback inter-act with each other to selectively maintain the link reliability and transmission efficiency. This also facilitates drive test on the AI functions at radio in terms of MDT (minimization of drive test), one of standardization aspects at 3GPP.

The proposed scheme in exemplary embodiments could facilitate the initial deployment of AI based functions or modems in a scale of commercial use, to provide balanced performance enhancement brought by AI enabled adaptivity and robustness (generality) provisioned by conventional (market proved) schemes. Since the AI/ML based solutions don't have a hard decision boundary the AI-enabled solutions also generalize better.

This proposed scheme in exemplary embodiments also provides a good leverage for minimization of drive-test, which is an important advantage for R&D phases, to save R&D cost.

FIG. 3 is a diagram showing an example of structure and key components of proposed heterogeneous transceiver, according to embodiments of the present disclosure.

The proposed heterogeneous transceiver (Data-driven & Model driven Integrated Transceiver (DMI-TRX)) possesses the following component features and association of them, as illustrated in FIG. 3.

ML transceiver (ML-TRX) is associated with a conventional one (C-TRX as its fallback version) to form a heterogeneous TRX. ML-TRX could support ML based transmissions and all payload data and control signaling as configured and activated through C-TRX channels.

This integrated transceiver is equipped with a pair of links: one is formed by C-TRX transmitter and receiver, and another is ML-TRX transmitter and receiver. Each link of transceivers could function respectively for data encoding, data frame (data unit) construction, modulation, pilot insertion at the data frames, demodulation, channel estimation/equalization with or without pilot inserted, data frame (data unit) parsing, demodulation, decoding.

C-TRX and ML-TRX differ in their roles in that, in general, C-TRX will mainly be responsible for control-plane, and ML-TRX will have a slight chance to that, in contrary, it will mainly operate for user-plane and mainly for payload data transmissions. Specifically, link setup, initiation (RA: random access), control channel (CCH), and termination (cellular handover signaling) are handled by C-TRX.

Signaling of activation or deactivation, scheduling, configuration of ML-TRX operation are also handled by C-TRX link.

Events/metrics triggering the activation of ML-TRX could include following cases.
1. First scenario for cases may be for radio environment context information updating. For instance, in high mobility or phase jittering cases, channel estimation or tracking is difficult with time-wise sparse pilot signal pattern, channel prediction/phase-shifting-resistance feature by ML-TRX is recommended to be triggered for payload data transmissions.
2. Second scenario for cases may be for occurrence and detection of C-TRX link hardware impairments. For an example, if the whole link is detected to be severely non-linear (due to nonlinearity of power amplifiers or low-cost radio units), ML-TRX operation could be enabled to achieve a certain level of relief of the effect caused by hardware impairments.
3. Third scenario for cases may be when higher transmission efficiency was determined and measured with ML-TRX channel. Such as, without pilot transmissions, ML-TRX could work with more radio resource shared as compared to the C-TRX and better symbol constellations adapting to the channel status.
4. Fourth scenario for cases may be for when RRC state is at active mode and ML-TRX feature is needed.

Radio base-station (RBS)/network-side may indicate the usage of ML-TRX or C-TRX to UE, by RRC signaling, DCI (downlink control information) or MAC command.

The models for ML-TRX could be trained with a cost function that maximizes spectral efficiency or a KPI (key performance indicator) that is similar to when using C-TRX. When the sub-optimality is detected according to the cost function, it identified a performance degradation of the ML model for a certain new change of scenario, it should be re-trained, and its weights are updated for ML-TRX after deactivation and will be reactivated again once completed fine-tuning phase. Events/metrics triggering the deactivation/switch of ML-TRX could include the following cases.
5. Fifth scenario for cases may be when lower transmission efficiency was detected and measured with ML-TRX channel, as compared to the C-TRX channels
6. Sixth scenario for cases may be for ML model drifts which cause performance degradations to a certain level so that the ML-TRX model need to be re-tuned or switched according to a certain criterion.
7. Seventh scenario for cases may be for radio environment context information updating which indicates that radio environment is benign so that low-complexity of C-TRX could perform well.
8. Eighth scenario for cases may be when computing resource becomes too tight so that switching to C-TRX is necessary.
9. Ninth scenario for cases may be when RRC state becomes inactive mode/idle mode so that most of the radio activity becomes management-oriented ones, C-TRX will be responsible for all the signaling transmissions.

Regarding illustration in FIG. 3, ML-TRX and C-TRX can be used in different function blocks. Within MAC and RRC layers, there are pairs of associated TRX logical/or substantial components of ML-TRX and C-TRX.

In the operation of Integrated Transceiver, overall radio resources are either statically or dynamically clustered into two PHY (physical) channel types: ML-TRX PHY channels, C-TRX PHY channels, so that ML-TRX and C-TRX respectively work over its type of radio channels.

Resource splitting could be dynamic per configuration/MAC control signaling or periodic/semi-persistent for each of these two channel types.

Resource splitting signaling is always over the C-TRX type of channels and transmitted and received by C-TRX.

In one example, synchronization signal (SS)/physical broadcast channel (PBCH) block: primary synchronization signal (PSS), secondary synchronization signal (SSS), PBCH always has a copy at C-TRX PHY channel (resource). Optionally, each of them has a copy at ML-TRX PHY.

In another example, physical downlink/uplink control channel (PD/UCCH) resides mainly in C-TRX type of radio resources/channels. UE always retreats to use C-TRX PD/UCCH resource/channels as a fallback when failures happen at ML-TRX resource/channels.

ML-TRX and C-TRX Tx and Rx are recommended to work over different radio resource blocks (time-frequency-space dimensions (T-F-S)), where
a. Time dimension units could be in a granularity of OFDM symbol, subframe, frame or frames,
b. Frequency dimension units could be in the granularity of subcarriers, PRB (physical resource block)s, sub-bands, bandwidth parts, carrier frequencies,
c. Spatial dimension units could be over different Tx/Rx panels, ports, beams, RBS sectors, RBS sites, CoMP (Coordinated Multiple Points) sets, etc.

It also implies that propagation characteristics of ML-TRX and C-TRX are different if the radio resource blocks assigned are different. Some channels may be more suitable for ML-TRX, and some channels may be more suitable for C-TRX. For example, the radio operates over two bands, one is higher band at higher microwave band and one is at lower band. In such cases, ML-TRX have more chances to work over the higher band while the C-TRX operate at lower band with a better propagation coverage (with a higher reliability or less signal distortion/impairments). Therefore, ML-TRX and C-TRX can be switched to use different radio resource blocks with respect to scheduling scheme considering difference between ML-TRX and C-TRX. A specific example is ML-TRX and C-TRX can be used in different bandwidth part (BWP) by UEs.

Alternatively, ML-TRX and C-TRX Tx and Rx can cover same radio resource blocks (T-F-S), but at different time occasions. In one example, UE can use configurations and operations in C-TRX as training data for ML-TRX. In another example, UE can obtain ‘diverse’ gain from ML-TRX and C-TRX.

C-TRX type of transceiver or its channels is used for feedback channels of ML-TRX.

Whenever the ML-RTX need to be further tuning on its model (such as neural-network models), feedback from receiver end to the transmitter end is a mandatory in most of cases. In such a case, a link formed by the C-TRX could be used for conveying the feedback of ML-TRX.

Specifically, this link/channel formed by C-TRX link offer to the ML-TRX link a special feedback tunnel, so that, a re-training/tuning of the ML-TRX could be enabled so that the ML-TRX could be updated online during its operation. This offers a desirable adaptivity for ML-TRX. C-TRX provided a robust tunnel to assist the ML-TRX's continuous updating during its operation.

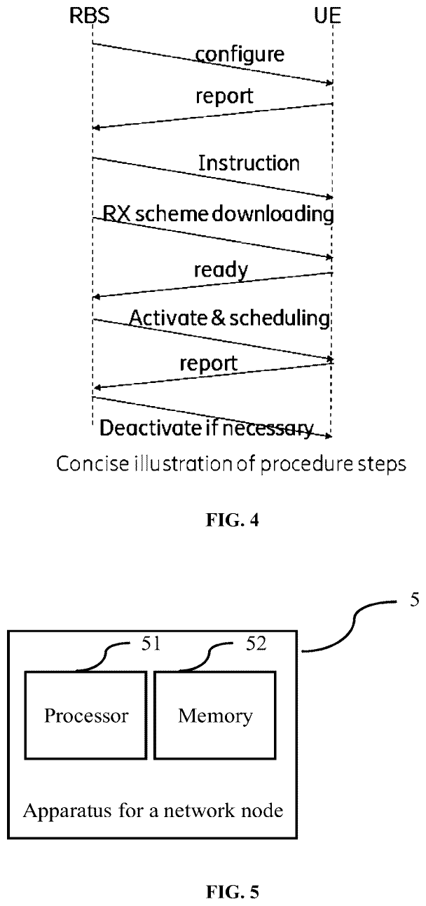

FIG. 4 is a diagram showing one example of control procedure including baseline of key control procedure and signaling, according to embodiments of the present disclosure.

As illustrated in FIG. 4, control mechanism, procedure and signaling may be further illustrated.

For radio base station (RBS), it configures the UEs of a DMI-TRX capability and determines the activation or deactivation of data-driven operations including training and inferences.

The radio base station may instruct computing capability measurement task at UEs if necessary.

The radio base station may determine the operational steps of UEs on formulating/releasing a data driven TRX branch. For instance, to form a data driven TRX, the steps could be: specifying the pre-trained data-driven model to be downloaded by UEs; requesting UEs' report on DMI-TRX's status, such as transmission error rates, signal to noise ratios; evaluating activation or deactivation of ML-TRX operation (switching back to C-TRX) based on UEs' report.

The radio base station may configure the UE on TRX HARQ (Hybrid Automatic Repeat reQuest)s, and link-quality relative measurement, such as signal strength, doppler shifts, and its reporting on ML-TRX and C-TRX, respectively for both the paths/channels.

For a UE, the associated signaling and procedure of the DMI-TRX scheme comprises following operations.

The UE may provide UE's capability of operating in a DMI-TRX mode or its computing capability to operate in a ML-TRX mode (a logical unit).

The UE may collect and store data and corresponding configurations conveyed over the C-TRX channels.

The UE may train DMI-TRX with data/feedback and corresponding configurations specified over C-TRX channels.

The UE may make operations simultaneously or alternatively on DMI-TRX with a C-TRX link and compare their KPIs, report the KPI results.

The UE may enable or disable DMI-TRX mode/or logical units at its hardware platform.

The exemplary embodiments may be also implemented for Minimization of Drive Tests (MDT).

MDT was standardized for NR in 3GPP standards Release-16 to reduce the amount of drive tests performed manually. It is a UE assisted framework where network measurements are collected by both IDLE/INACTIVE UEs and RRC_CONNECTED UE(s) in order to aid the network in gathering valuable information on its operation. It has been specified for both LTE and NR in TS 37.320 V17.1.0 (2022-06).

In the proposal in exemplary embodiments of the present disclosure, an MDT feature to have these heterogeneous functions are used to facilitate the initial validation of AI modules in the radio. For example, C-TRX channel could be a path for MDT information about ML-TRX operation status or measurements to network side. Specifically, MDT provides more detailed information about the operations of UE on switching and CQI (channel quality indicator) through performing periodical or event triggered MDT logging after receiving the MDT configurations from the network.

The UE shall report the utilization of ML-TRX and C-TRX together with time information, e.g., each switching time, detailed location information if available to the network via using the UE information framework when it is in RRC_CONNECTED state. C-TRX channel or link could support ML-TRX MDT reports.

In one example, the UE is configured with ML-TRX and C-TRX as part of the logged MDT configuration that indicates to the UE that the UE shall perform the logging of MDT measurements when the UE switches ML-TRX and C-TRX or enable/deactivate ML-TRX modes.

FIG. 5 is a block diagram showing exemplary apparatuses suitable for practicing the network node, according to embodiments of the disclosure.

As shown in FIG. 5, the apparatus 5 for the network node may comprise: a processor 51; and a memory 52. The memory 52 contains instructions executable by the processor 51, whereby the apparatus is operative for: transmitting an instruction to a terminal device, to activate the communication link; and communicating with the terminal device, by using the communication link. The first type of communication link is based on data driven artificial intelligence. The communication link is of a first type or a second type. Optionally, the apparatus may be further operative for: before transmitting the instruction to the terminal device, determining to use a communication like of a first type or a second type. The instruction may activate the determined communication link.

Further, the apparatus 5 may be operative to perform the method according to any of the above embodiments, such as these shown in FIG. 1B, 1C.

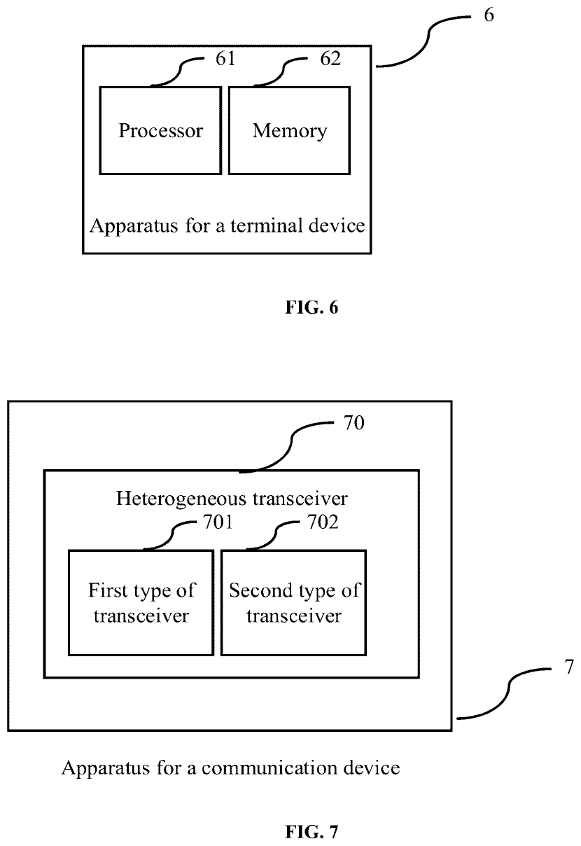

FIG. 6 is a block diagram showing exemplary apparatuses suitable for practicing the terminal device, according to embodiments of the disclosure.

As shown in FIG. 6, the apparatus 6 for the terminal device may comprise: a processor 61; and a memory 62. The memory 62 contains instructions executable by the processor 61, whereby the apparatus is operative for: receiving an instruction from a network node, to activate a communication link; and communicating with the network node, by using the communication link. The communication link is a first type of communication link or a second type of communication link. The first type of communication link is based on data driven artificial intelligence.

Further, the apparatus 6 may be operative to perform the method according to any of the above embodiments, such as these shown in FIG. 2B, 2C, 2D.

The processors 51, 61 may be any kind of processing component, such as one or more microprocessor or microcontrollers, as well as other digital hardware, which may include digital signal processors (DSPs), special-purpose digital logic, and the like. The memories 52, 62 may be any kind of storage component, such as read-only memory (ROM), random-access memory, cache memory, flash memory devices, optical storage devices, etc.

FIG. 7 is a block diagram showing exemplary apparatuses suitable for practicing a communicating device, according to embodiments of the disclosure.

As shown in FIG. 7, an apparatus 7 for a communication device (such as the network node, or the terminal device) comprises: a heterogeneous transceiver 70. The heterogeneous transceiver 70 comprises a first type of transceiver 701 and a second type of transceiver 702; and the first type of transceiver 701 is based on data driven artificial intelligence.

In exemplary embodiments of the present disclosure, the second type of transceiver 702 is based on model-driven design utilizing expertise on physics and mathematical derivations.

In exemplary embodiments of the present disclosure, the first type of transceiver 701 comprises a machine learning transceiver; and/or the second type of transceiver 702 comprise a model-driven transceiver based on at least one of: 2G, 3G, 4G, or 5G communication standard.

In exemplary embodiments of the present disclosure, at least one of a radio resource control unit, a media access control unit, and/or a signal frame generation unit of the first type of transceiver comprises a data-driven module.

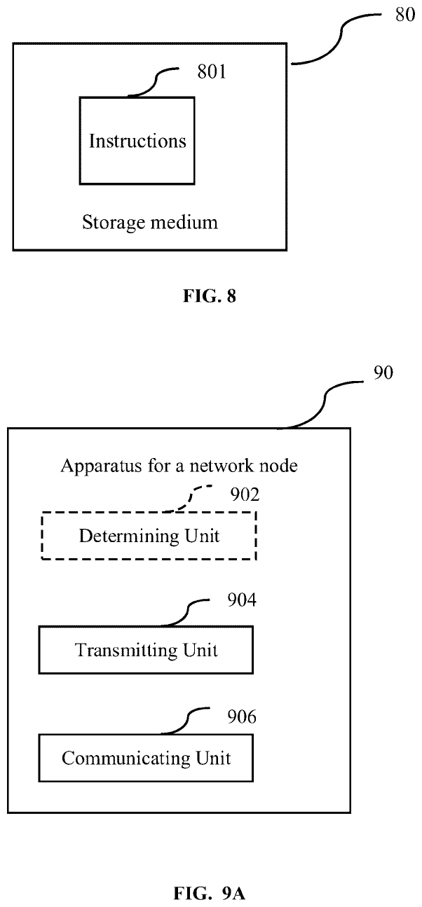

FIG. 8 is a block diagram showing an apparatus readable storage medium, according to embodiments of the present disclosure.

As shown in FIG. 8, the computer-readable storage medium 80, or any other kind of product, storing instructions 801 which when executed by at least one processor, cause the at least one processor to perform the method according to any one of the above embodiments, such as these shown in FIG. 1A, 1B, 1C, 2A, 2B, 2C, 2D.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

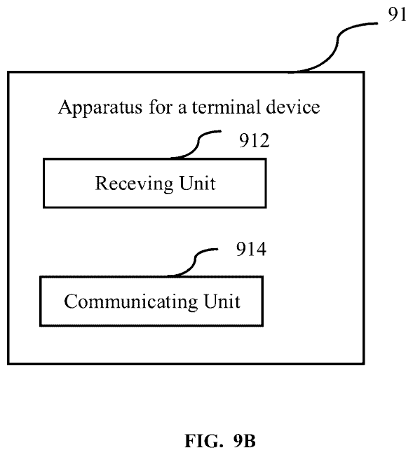

FIG. 9A is a schematic showing units for the apparatus for a network node, according to embodiments of the present disclosure.

In embodiments of the present disclosure, the apparatus 90 may comprise: a transmitting unit 904, configured for transmitting an instruction to a terminal device, to activate the communication link; and a communicating unit 906, communicating with the terminal device, by using the communication link. The first type of communication link is based on data driven artificial intelligence. The communication link is of a first type or a second type.

Optionally, the apparatus 90 may further comprise: a determining unit 902, configured for determining to use a communication link of a first type or a second type, before transmitting the instruction to the terminal device. The instruction may active the determined communication link.

In embodiments of the present disclosure, the apparatus is further operative to perform the method according to any of embodiments above described, such as shown in FIG. 1A, 1B, 1C.

FIG. 9B is a schematic showing units for the apparatus for a terminal device, according to embodiments of the present disclosure.

In embodiments of the present disclosure, the apparatus 91 may comprise: a receiving unit 912, configured for receiving an instruction from a network node, to activate a communication link; and a communicating unit 914, configured for communicating with the network node, by using the communication link. The communication link is a first type of communication link or a second type of communication link. The first type of communication link is based on data driven artificial intelligence.

In embodiments of the present disclosure, the apparatus is further operative to perform the method according to any of embodiments above described, such as shown in FIG. 2A, 2B, 2C, 2D.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the apparatus 90, 91 may not need a fixed processor or memory, any computing resource and storage resource may be arranged from at least one network node/device/entity/apparatus relating to the communication system. The virtualization technology and network computing technology (e.g. cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

Examples structures for the network node, terminal device (such as a UE), may be illustrated as follows.

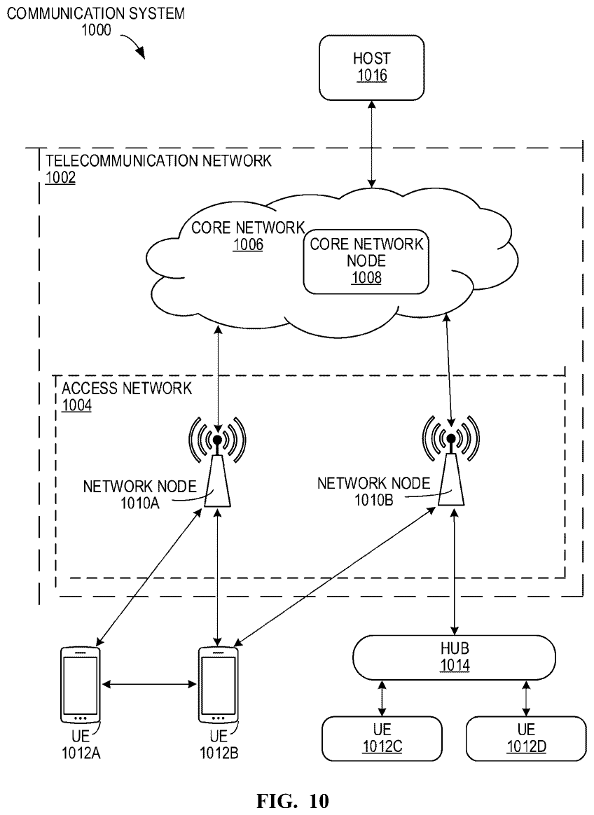

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

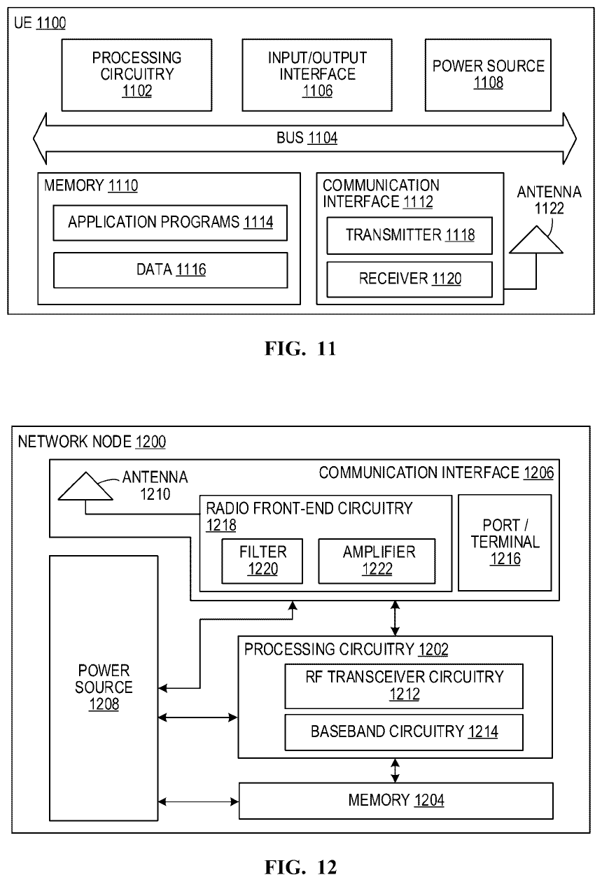

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

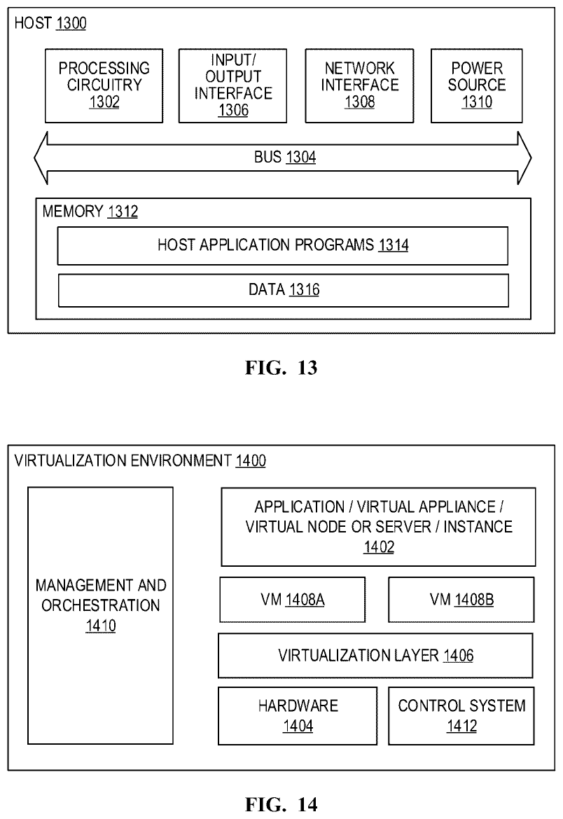

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312.

Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

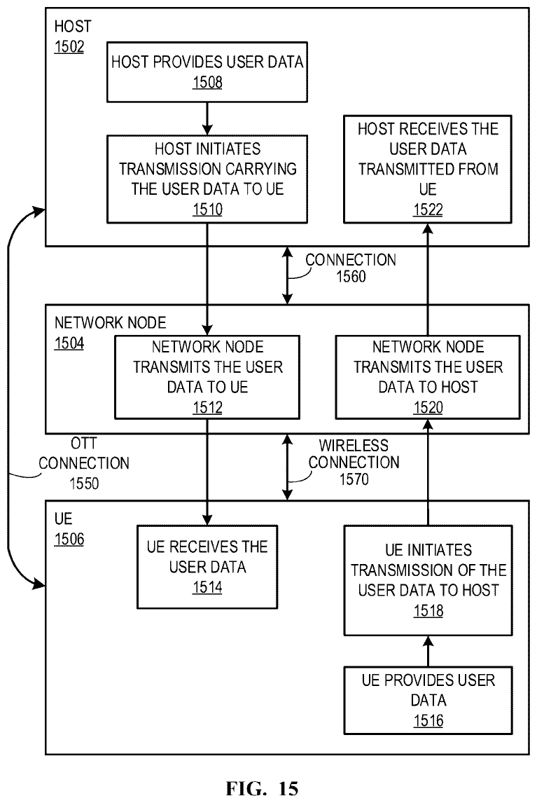

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, improved methods and improved apparatuses for controlling communication link between communication devices may be provided. For example, in embodiments herein, at least two types of communication link may be utilized. Particularly, communication link based on data driven artificial intelligence may be selected from these two types of communication links, according to scenarios. Learning capability of artificial intelligence creates advantageous policy or strategies directly based on data instead of human logics and symbolic modeling and analysis. Therefore, the solution for communication links might be superior. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In general, the various exemplary embodiments of the present disclosure may be implemented in hardware or special purpose circuits, software, logic or any combination thereof. For example, some aspects may be implemented in hardware, while other aspects may be implemented in firmware or software that may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may include circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

| Abbreviation | Explanation |
|---|---|
| AI | Artificial Intelligence |
| BS | Base Station |
| CE | Channel Estimate |
| MAC | Medium Access Control |
| ML | Machine Learning |
| PBCH | Physical Broadcast Channel |
| PSS | Primary Synchronization Signal |
| RRC | Radio Resource Control |
| RF | Radio Frequency |
| SSS | Secondary Synchronization Signal |
| TRX | Transceiver |
| UE | User Equipment |

### REFERENCES

The followings are the references which are incorporated herein in their entirety:
3GPP TS 37.320 V17.1.0 (2022-06) “Radio measurement collection for Minimization of Drive Tests (MDT); Overall description; Stage 2 (Release 17)”

1. A method performed by a network node, comprising:
transmitting an instruction to a terminal device, to activate a communication link, wherein the communication link is of a first type or a second type; and
communicating with the terminal device, by using the communication link;
wherein the first type of communication link is based on data driven artificial intelligence.

2. The method according to claim 1,
wherein the instruction configures and/or schedules the communication link; and/or
wherein the second type of communication link is based on model-driven design utilizing expertise on physics and mathematical derivations.

3-4. (canceled)

5. The method according to claim 1, further comprising:
transmitting to the terminal device a configuration for the communication link to receive or transmit data, or to provide a report; wherein the type of the communication link is used based at least on the report.

6. The method according to claim 5, wherein the report comprises at least one of:
a transmission error rate;
a signal to noise ratios;
a signal strength;
doppler shifts;
a capability of the terminal device to support the first type of communication link and/or the second type of communication link; and/or
a computing capability of the terminal device.

7. The method according to claim 1, further comprising:
transmitting an instruction to the terminal device to download a pre-trained data-driven model, when the type of communication link is the first type; and/or
transmitting an instruction to the terminal device to deactivate the first type of communication link and fallback to the second type of communication link.

8-9. (canceled)

10. The method according to claim 1,
wherein the first type of communication link is configured for user plane, the second type of communication link is configured for control plane; and/or
wherein the first type of communication link and the second communication link are configured to use different radio resource blocks or same radio resource bands but at different time occasions.

11. The method according to claim 1, wherein the first type is used in at least one of the following condition:
when the terminal device is in a high mobility or severe phase jittering case;
when a link hardware impairment happens in the second type of communication link; and/or
when the first type of communication link has a higher transmission efficiency than the second type of communication link.

12. The method according to claim 1, wherein the second type is used in at least one of the following condition:
when the first type of communication link has a lower transmission efficiency than the second type of communication link;
when a degradation due to model-drift happens in the first type of communication link;
when a radio environment is suitable for the second type of communication link; and/or
when a computing resource is insufficient to support the first type of communication link.

13. The method according to claim 1,
wherein the network node uses a radio resource control signaling, downlink/uplink control information and/or media access control command to instruct the terminal device; and/or
wherein the network node comprises a base station.

14. A method performed by a terminal device, comprising:
receiving an instruction from a network node, to activate a communication link; and
communicating with the network node, by using the communication link;
wherein the communication link is a first type of communication link or a second type of communication link; and
wherein the first type of communication link is based on data driven artificial intelligence.

15. The method according to claim 14,
wherein the instruction configures and/or schedules the communication link; and/or
wherein the second type of communication link is based on model-driven design utilizing expertise on physics and mathematical derivations.

16-17. (canceled)

18. The method according to claim 14, further comprising:
receiving from the network node a configuration for the communication link to receive or transmit data, or to provide a report; wherein the type of the communication link is used based at least on the report.

19. The method according to claim 18, wherein the report comprises at least one of:
a transmission error rate;
a signal to noise ratios;
a signal strength;
doppler shifts;
a capability of the terminal device to support the first type of communication link and/or
the second type of communication link; and/or
a computing capability of the terminal device.

20. The method according to claim 14, further comprising
receiving an instruction from the network node to download a pre-trained data-driven model, when the type of communication link is the first type; and/or
receiving an instruction from the network node to deactivate the first type of communication link and fallback to the second type of communication link.

21. (canceled)

22. The method according to claim 14, further comprising:
training a model in the first type of communication link with data/feedback and configuration specified over the second type of communication link; and/or
enabling or disabling the first type of communication link based on comparison between performance of the first type of communication link and the second type of communication link.

23. (canceled)

24. The method according to claim 14,
wherein the communication link comprises at least radio resource control unit, media access control unit, and signal frame generation unit; and
wherein at least one of the radio resource control unit, the media access control unit, and/or the signal frame generation unit of the first type of communication link comprises a data-driven module.

25. The method according to claim 14,
wherein the first type of communication link is configured for user plane, the second type of communication link is configured for control plane; and/or
wherein the first type of communication link and the second communication link are configured to use different radio resource blocks or same radio resource bands but at different time occasions.

26. The method according to claim 14,
wherein the first type is used in at least one of the following condition:
when the terminal device is in a high mobility or severe phase jittering case;
when a link hardware impairment happens in the second type of communication link; and/or
when the first type of communication link has a higher transmission efficiency than the second type of communication link.

27. The method according to claim 14, wherein the second type is used in at least one of the following condition:
when the first type of communication link has a lower transmission efficiency than the second type of communication link;
when a degradation due to model drift happens in the first type of communication link;
when a radio environment is suitable for the second type of communication link; and/or
when a computing resource is insufficient to support the first type of communication link.

28. The method according to claim 14,
wherein the terminal device uses a radio resource control signaling, downlink/uplink control information and/or media access control command to receive an instruction from the network node; and/or
wherein the network node comprises a base station.

29-30. (canceled)

31. An apparatus for a terminal device, comprising:
a processor; and
a memory, the memory containing instructions executable by the processor, whereby the apparatus for the terminal device is operative for:
receiving an instruction from a network node, to activate a communication link; and
communicating with the network node, by using the communication link;
wherein the communication link is a first type of communication link or a second type of communication link; and
wherein the first type of communication link is based on data driven artificial intelligence.

32-34. (canceled)

35. The apparatus according to claim 31,
Wherein a first type of transceiver comprises a machine learning transceiver; and/or
Wherein a second type of transceiver comprises a model-driven transceiver based on at least one of: 2G, 3G, 4G, or 5G communication standard.

36. The apparatus according to claim 31, wherein at least one of a radio resource control unit, a media access control unit, and/or a signal frame generation unit of the first type of transceiver comprises a data-driven module.

37. (canceled)
